(19) United States
(12) Patent Application Publication
(10) Pub. No.: US 2008/0204823 A1
(43) Pub. Date: Aug. 28, 2008

(54) Compensating Method for Image Scanning, Image Scanning Apparatus and Image Processing System

(76) Inventor: Sheng-Min Wang, Keelung City (TW)

Correspondence Address: NORTH AMERICA INTELLECTUAL PROPERTY CORPORATION, P.O. BOX 506, MERRIFIELD, VA, 22116, US

(21) Appl. No.: 11/872,721

(22) Filed: Oct. 16, 2007

(30) Foreign Application Priority Data
Feb. 26, 2007 (TW) 096106555

(51) Int. Cl. H04N 1/04

(52) U.S. Cl. 358/494

(57) ABSTRACT

A compensating method for image scanning measures original optical values corresponding to a plurality of scan lines in a frame using a plurality of channels. First, a reference channel is selected from the plurality of channels. Based on the differences between the actual exposure locations of the reference channel and other channels on the frame, corresponding weighting values are then generated for compensating the original optical values measured by other channels, thereby generating the correction optical values for other channels.

### BACKGROUND OF THE INVENTION

1. Field of the Invention

The present invention is related to a scanning method and related apparatuses, especially a scanning method and related apparatuses capable of compensating image quality.

2. Description of the Prior Art

A contact image sensor (CIS) is one kind of linear sensors, and is often used on devices such as scanners, fax machines, or multi functional printers, for scanning and transforming graphics or documents into digital image data, so that users can edit the image data through a computer, print through a printer, send to others via fax or e-mail, and share with others through Internet.

Please refer to FIG. 1, which illustrates a schematic diagram of a prior art CIS scanner scanning under ideal conditions. Suppose a document 10, which is to be scanned by the CIS scanner, includes a fully black area and a fully white area, a blank area in FIG. 1 represents the white part in the document 10, and a slash area represents the black part. When scanning images, the prior art CIS scanner moves an optic sensing module from above to the bottom of the document 10 with a stepping motor. That is to say, the scanner driven by the stepping motor scans the document 10 line by line with a fixed interval distance P. During the moving process, the optic sensing module of the CIS scanner sends light sources to the document 10 through a red channel, a green channel, and a blue channel. Then, light sensing element arrays of the CIS scanner are able to sequentially receive reflected signals corresponding to the red, green, and blue light sources from the document 10, so as to generate a plurality of scan lines, and convert chrominance and luminance data of each scan line to electronic signals. Take scan lines S_{N} to S_{N+3} (represented by broken lines in FIG. 1) of the document 10 for example: R_{N}˜R_{N+3} represent optical values obtained by the red channel from the scan lines S_{N} to S_{N+3}, G_{N}˜G_{N+3} represent optical values obtained by the green channel from the scan lines S_{N} to S_{N+3}, and B_{N}˜B_{N+3} represent optical values obtained by the blue channel from the scan lines S_{N} to S_{N+3}. In addition, the scan lines S_{N+1} and S_{N+2} are located at the black part of the document 10, and the scan lines S_{N} and S_{N+3} are located at the white part. Under ideal conditions, when the CIS scanner starts to read data of a scan line of the document 10, exposure locations of the red, green, and blue channels corresponding to the scan line are exactly the same. In other words, for the scan lines S_{N} and S_{N+3}, the red, green, and blue channels all sense the white part of the document 10, while for the scan lines S_{N+1} and S_{N+2}, the red, green, and blue channels all sense the black part of the document 10.

Referring to FIG. 2, a schematic diagram of the prior art CIS scanner outputting images under ideal conditions. Image signals V_{N}˜V_{N+3} respectively represent output image signals of the scan lines S_{N} to S_{N+3} of the document 10. The image signal V_{N} is obtained from the optical values R_{N}, G_{N}, and B_{N}, the image signal V_{N+1} is obtained from the optical values R_{N+1}, G_{N+1}, and B_{N+1}, the image signal V_{N+2} is obtained from the optical values R_{N+2}, G_{N+2}, and B_{N+2}, and the image signal V_{N+3} is obtained from the optical values R_{N+3}, G_{N+3}, and B_{N+3}. Under ideal conditions, since the exposure locations of the red, green, and blue channels corresponding to each scan line of the document 10 are exactly the same, the image signals V_{N} and V_{N+3} obtained by the CIS scanner from the scan lines S_{N} and S_{N+3} are corresponding to the fully white images of the document 10, and the image signals V_{N+1} and V_{N+2} obtained from the scan lines S_{N+1} and S_{N+2} are corresponding to the fully black images of the document 10. Therefore, under ideal conditions, the output image signals V_{N}˜V_{N+3} can accurately represent the black-white boundaries of the document 10.

Nevertheless, in reality, the CIS scanner forms an image by using the stepping motor to drive the sensor module, exposing the red, green, and blue channel line by line to receive reflection light signals. For instance, the first line exposures the red channel, the second line exposures the green channels, the third line exposures the blue channel, the fourth line exposures the red channel, and so on. Since the CIS scanner can only handle the reflection light of one single color during the same exposure duration, the red, green, and blue channels corresponding to the same scan line are measured on different positions.

Please refer to FIG. 3, which illustrates a schematic diagram of an actual scanning operation of the prior art CIS scanner. In FIG. 3, the document 10, to be scanned by the CIS scanner, contains a fully black area and a fully white area, the blank space in FIG. 3 represents the white part of the document 10, and the slash area represents the black part of the document 10. Take scan lines S_{N} to S_{N+3} (represented by broken lines in FIG. 3) for example: R_{N}˜R_{N+3} represent optical values obtained by the red channel from the scan lines S_{N} to S_{N+3}, G_{N}˜G_{N+3} represent optical values obtained by the green channel from the scan lines S_{N} to S_{N+3}, and B_{N}˜B_{N+3} represent optical values obtained by the blue channel from the scan lines S_{N} to S_{N+3}. Since the CIS scanner sequentially exposures the red, green, and blue channels during the moving process, and only reflection light of a single color can be handled during the same exposure duration, there is a difference on the actual exposure locations of the red, green, and blue channels towards the same scan line (represented by an arrow in FIG. 3). In other words, for the scan line S_{N} located on the white part, the red, green, and blue channels all sense the white part of the document 10. For the scan line S_{N+1} located on the black part, the red channel senses the white part of the document 10, and the green and blue channels sense the black part of the document 10. For the scan line S_{N+2}, the red, green, and blue channels all sense the black part of the document 10. For the scan line S_{N+3} located on the white part of the document 10, the red channel senses the black part of the document 10, and the green and blue channels sense the white part.

Please refer to FIG. 4, which illustrates a schematic diagram of the light imaging theory. In general, red, blue, and green are chosen as three primary colors of light, and all colors can be generated through combinations of the three colors. Color of an object seen by human eyes depends on color contents of incident light, reflection light, or transmission light when light illuminates the object. Color of a transparent object depends on the color light itself can transmit, while color of an opaque is the color of the reflected light. If an object can reflect or transmit two or more colors of light, color of the object is mixture of these colors. For instance, if an opaque can reflect red, blue, and green lights, color of the opaque is mixture of these three colors, which is white. If an opaque can absorb red, blue, green lights, color of the opaque is mutual exclusion of red, blue, and green lights, which is black.

Please refer to FIG. 5, which is a schematic diagram of real image outputs of the prior art CIS scanner. Image signals V_{N}˜V_{N+3} respectively represent output image signals of the scan lines S_{N} to S_{N+3} of the document 10. The image signal V_{N} is obtained from the optical values R_{N}, G_{N}, and B_{N}, the image signal V_{N+1} is obtained from the optical values R_{N+1}, G_{N+1}, and B_{N+1}, the image signal V_{N+2} is obtained from the optical values R_{N+2}, G_{N+2}, and B_{N+2}, and the image signal V_{N+3} is obtained from the optical values R_{N+3}, G_{N+3}, and B_{N+3}. Since exposure locations of different channels corresponding to each scan line of the document 10 are different, FIG. 3 reveals that the optic values R_{N}, G_{N}, and B_{N} are corresponding to the fully white images, the optic values R_{N+1}, G_{N+1}, and B_{N+1} are corresponding to the fully white, fully black and fully black images respectively, the optic values R_{N+2}, G_{N+2}, and B_{N+2} are corresponding to the fully black images, and the optic values R_{N+3}, G_{N+3}, and B_{N+3} are corresponding to the fully black, fully white, and fully white images respectively. Referring to the imaging diagram in FIG. 4, the image signal V_{N} obtained by the CIS scanner from the scan line S_{N} of the document 10 is corresponding to a fully white image, the image signal V_{N+1} obtained from the scan line S_{N+1} is corresponding to a red image, the image signal V_{N+2} obtained from the scan line S_{N+2} is corresponding to a fully black image, and the image signal V_{N+3} obtained from the scan line S_{N+3} is corresponding to a watchet image. Compared to the ideal output image shown in FIG. 2, the prior art CIS scanner creates color stripes when scanning black-white boundaries, which do not exist in the original document 10, cause color registration distortion, and affect the afterwards image processes.

### SUMMARY OF THE INVENTION

It is therefore a primary objective of the present invention to provide a compensating method for image scanning, an image scanning apparatus and an image processing system.

The present invention discloses an image scanning compensating method. The image scanning compensating method comprises moving an optic sensing module for sequentially scanning a frame and generating a plurality of scan lines, reading a first original optic value, a second original optic value, and a third original optic value corresponding to an N-th scan line of the plurality of scan lines through a first channel, a second channel, and a third channel of the optic sensing module, reading a fourth original optic value, a fifth original optic value, and a sixth original optic value corresponding to a (N+1)-th scan line of the plurality of scan lines through the first channel, the second channel, and the third channel of the optic sensing module, choosing a reference channel from the first channel to the third channel, adjusting the first original optic value to the third original optic value respectively for generating a first optic compensating signal to a third optic compensating signal according to differences of actual exposure location of the reference channel and actual exposure locations of the first channel to the third channel other than the reference channel when reading the N-th scan line, adjusting the fourth original optic value to the sixth original optic value respectively for generating a fourth optic compensating signal to a sixth optic compensating signal according to differences of actual exposure locations of the first channel to the third channel other than the reference channel when reading the (N+1)-th scan line and the actual exposure location of the reference channel when reading the N-th scan line, generating a first correction optic value corresponding to the first channel and the N-th scan line according to the first optic compensating signal and the fourth optic compensating signal, generating a second correction optic value corresponding to the second channel and the N-th scan line according to the second optic compensating signal and the fifth optic compensating signal, generating a third correction optic value corresponding to the third channel and the N-th scan line according to the third optic compensating signal and the sixth optic compensating signal, and outputting image signals corresponding to the N-th scan line according to the first correction optic value to the third correction optic value.

The present invention further discloses an image scanning apparatus capable of compensating images. The image scanning apparatus comprises an optic sensing module comprising a plurality of channels, for providing light sources for a frame, detecting a plurality of original optic values based on reflection of the frame, and converting the plurality of original optic values to a plurality of analog signals, an analog-to-digital converter for converting the plurality of analog signals to a plurality of digital signals, and a controller for adjusting the plurality of digital signals respectively according to differences of actual exposure locations of the plurality of channels on the frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art CIS scanner when scanning under ideal conditions.

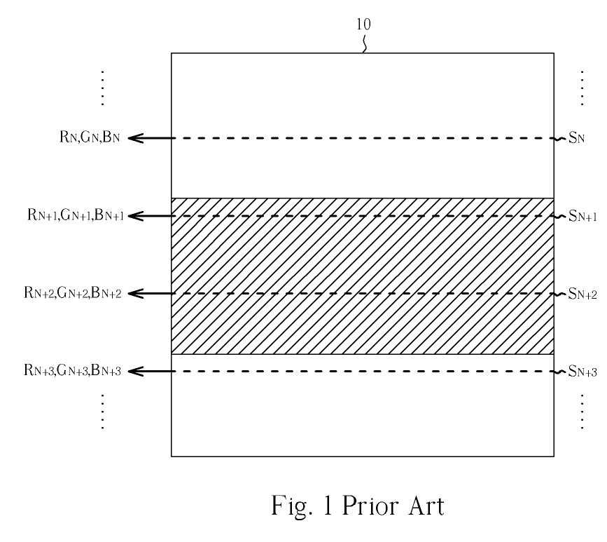

FIG. 2 illustrates a schematic diagram of a prior art CIS scanner when outputting images under ideal conditions.

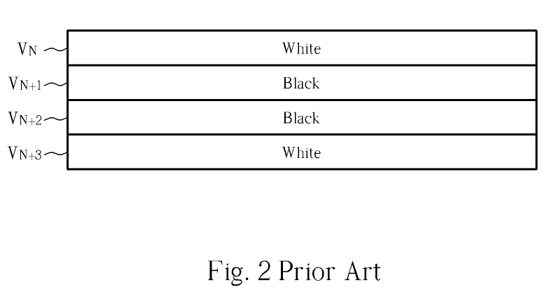

FIG. 3 illustrates a schematic diagram of an actual scanning operation of a prior art CIS scanner.

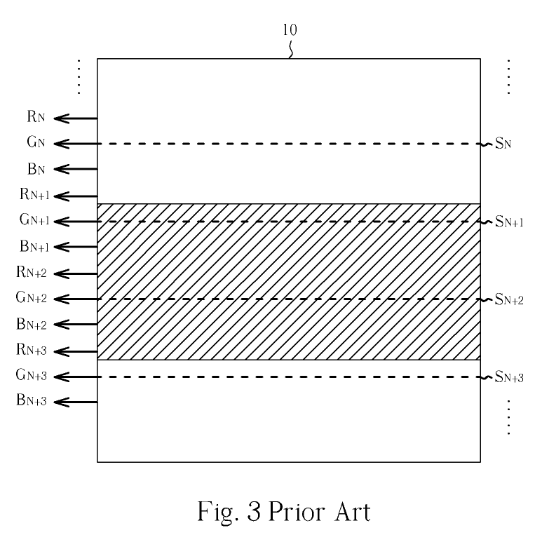

FIG. 4 illustrates a schematic diagram of the light imaging theory.

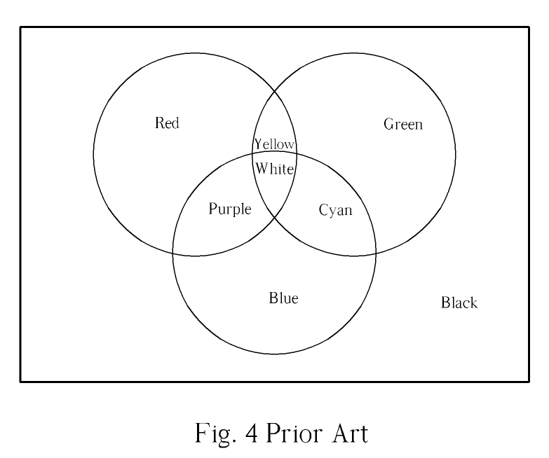

FIG. 5 illustrates a schematic diagram of real image outputs of a prior art CIS scanner.

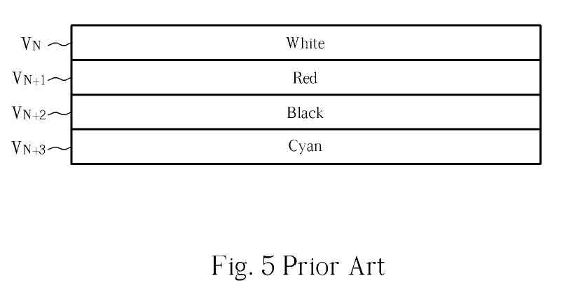

FIG. 6 illustrates a schematic diagram of a CIS scanner when scanning according to the present invention.

FIG. 7 illustrates a diagram of relation between an original optic value and a correction optic value according to a first embodiment of the present invention.

FIG. 8 illustrates a diagram of relation between an original optic value and a correction optic value according to a second embodiment of the present invention.

FIG. 9 illustrates a diagram of relation between an original optic value and a correction optic value according to a third embodiment of the present invention.

FIG. 10 illustrates a schematic diagram of an image processing system according to the present invention.

### DETAILED DESCRIPTION

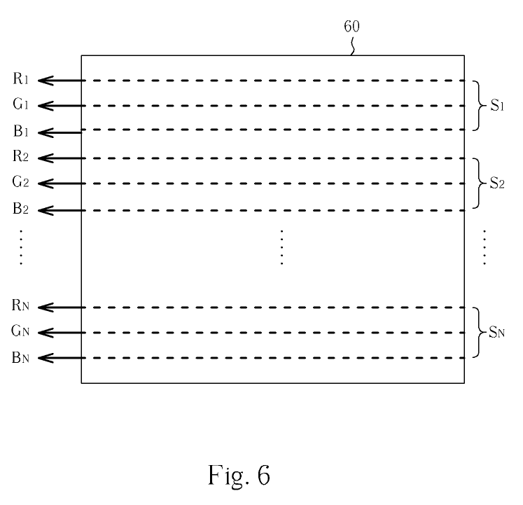

Please refer to FIG. 6, which illustrates a schematic diagram of a CIS scanner when performing scan operations in accordance with the present invention. Suppose that a stepping motor of the CIS scanner moves in uniform motion. When scanning images, an optic sensing module of the CIS scanner scans a document 60 from top to bottom in uniform motion, so as to read optic values corresponding to scan line S₁ to scan line S_{N} sequentially. In FIG. 6, broken lines represent the exposure locations on the document 60 corresponding to red, green and blue channels. R₁˜R_{N} respectively represent optic values obtained by the red channel from the scan lines S₁ to S_{N}, G₁˜G_{N} respectively represent optic values obtained by the green channel from the scan lines S₁ to S_{N}, and B₁˜B_{N} respectively represent optic values obtained by the blue channel from the scan lines S₁ to S_{N}. In order to compensate the optic signal differences caused by differences of actual exposure location of different channels when the CIS scans, the present invention chooses a reference channel from the red channel, green channel, and blue channel, and generates a corresponding weighting value based on the actual exposure locations of the reference channel and other channels, and uses the weighting value for correcting the original optic value of other channels, so as to generate a corresponding correction optic value.

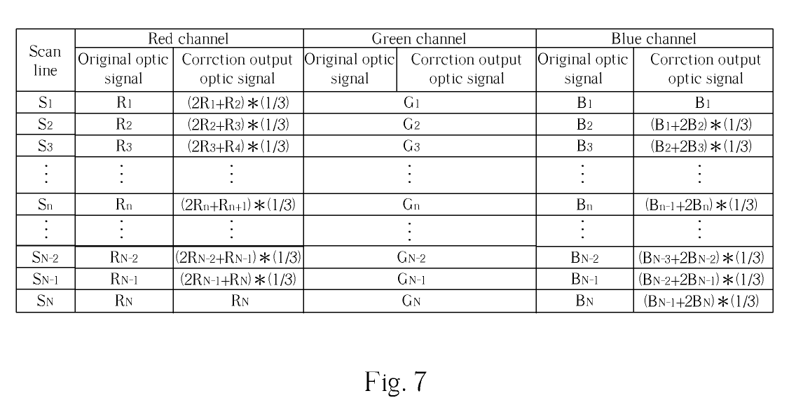

Please refer to FIG. 7, which illustrates a schematic diagram of relation between the original optic value and the correction optic value according to a first embodiment of the present invention. In the first embodiment of the present invention, the scanning order is red, green and blue channel. The green channel is in the middle, and is selected as a reference channel. The optic values G₁˜G_{N} obtained from the scan lines S₁ to Sₙ of the document 60 through the green channel are taken as the reference signals. Take scan line Sₙ as an example (n is an integer between 1 and N), the first embodiment of the present invention adjusts the optic values Rₙ and Bₙ based on Gₙ. Comparing the actual exposure locations of the optic values Rₙ and Rₙ₊₁ measured by the red channel with the actual exposure location of the reference signal (optic value Gₙ) measured by the reference channel (green channel), the distance ratio between the optic values Rₙ and Rₙ₊₁ corresponding to the optic value Gₙ is 1:2. Hence, taking adjusting the red channel as an example, in the first embodiment of the present invention, the correction signal of the red channel on the location of the green reference signal can be obtained by interpolation. Since the distance ratio of the optic values Rₙ and Rₙ₊₁ corresponding to the optic value Gₙ is 1:2, the weight values are set as ⅔ and ⅓, and the first embodiment of the present invention adjusts the correction optic value when the red channel measures the scan line Sₙ to be (2Rₙ+Rₙ₊₁)/3 correspondingly. By the same token, comparing the actual exposure locations of the optic values Bₙ₋₁ and Bₙ measured by the blue channel with the actual exposure location of the reference signal (optic value Gₙ) measured by the reference channel (green channel), the distance ratio between the optic values Bₙ₋₁ and Bₙ corresponding to the optic value Gₙ is 2:1. Hence, taking adjusting the blue channel as an example, in the first embodiment of the present invention, the correction signal of the blue channel on the location of the green reference signal is obtained by linear interpolation. Since the distance ratio between the distance of the optic values Bₙ₋₁ and Bₙ corresponding to the optic value Gₙ is 2:1, the weighting value is set as ⅓ and ⅔ respectively, and the correction optic value is adjusted to be (Bₙ₋₁+2Bₙ)/3 when the blue channel is measuring scan line Sₙ. In the first embodiment of the present invention, the green channel is the reference channel, so the correction optic value is the same as the original optic value Gₙ when the green channel is measuring scan line Sₙ.

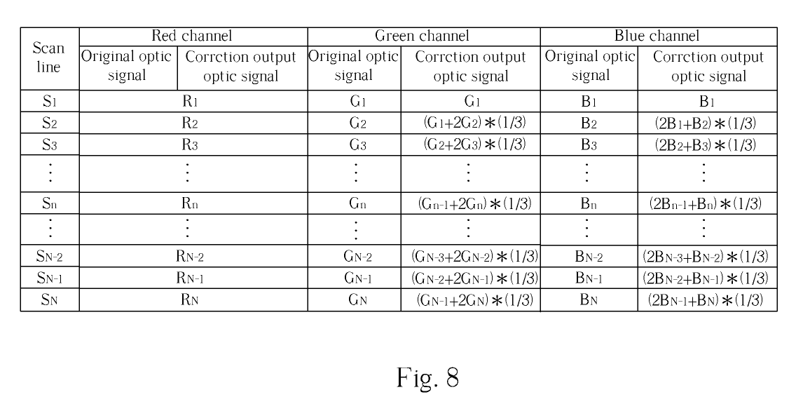

Please refer to FIG. 8, which illustrates a schematic diagram of relation between the original optic value and the correction optic value according to a second embodiment of the present invention. In the second embodiment of the present invention, a red channel is selected as a reference channel, and the optic values R₁-R_{N} obtained from the red channel corresponding to the scan lines S₁ to S_{N} are set as reference signals. Take the scan line Sₙ as an example (n is an integer between 1 and N), the second embodiment adjusts optic values Gₙ and Bₙ based on the optic value Rₙ. Comparing the actual exposure locations of the optic value Gₙ₋₁ and Gₙ measured by the green channel with the actual exposure location of the reference signal (optic value Rₙ) measured by the reference channel (red channel), the distance ratio between the optic values Gₙ₋₁ and Gₙ corresponding to the optic value Rₙ is 2:1. Hence, taking adjusting the green channel as an example, in the second embodiment of the present invention, the correction signal of the green channel on the location of the red reference signal is obtained by linear interpolation. Since the distance ratio between the distance of the optic value Gₙ₋₁ and Gₙ corresponding to the optic value Rₙ is 2:1, the weighting value is set as ⅓ and ⅔ respectively, and the correction optic value is adjusted to be (Gₙ₋₁+2Gₙ)/3 when the green channel is measuring scan line Sₙ. By the same token, comparing the actual exposure locations of the optic values Bₙ₋₁ and Bₙ measured by the blue channel with the exposure location of the reference signal (optic value Rₙ) measured by the reference channel (red channel), the distance ratio between the optic values Bₙ₋₁ and Bₙ corresponding to the optic value Rₙ is 1:2. Hence, taking adjusting the blue channel as an example, in the second embodiment of the present invention, the correction signal of the blue channel on the location of the red reference signal is obtained by linear interpolation. Since the distance ratio between the distance of the optic values Bₙ₋₁ and Bₙ corresponding to the optic value Rₙ is 1:2, the weighting value is set as ⅔ and ⅓ respectively, and the correction optic value is adjusted to be (2Bₙ₋₁+Bₙ)/3 when the blue channel is measuring the scan line Sₙ. In the second embodiment of the present invention, the red channel is the reference channel, so the correction optic value is the same as the original optic value Rₙ when the red channel is measuring the scan line Sₙ.

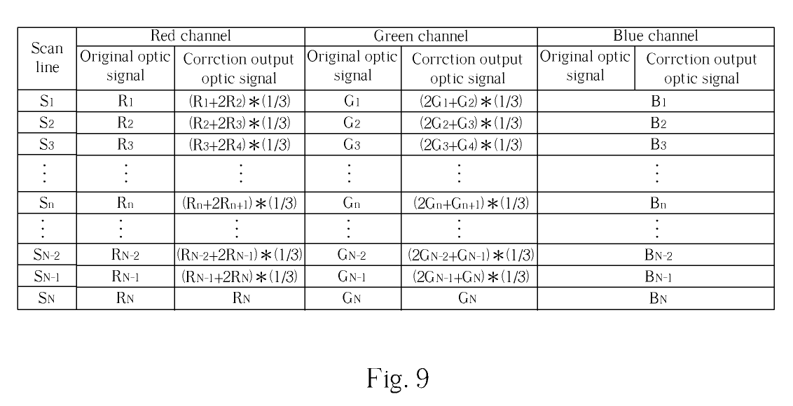

Please refer to FIG. 9, which illustrates a schematic diagram of relation between the original optic value and the correction optic value according to a third embodiment of the present invention. In the third embodiment of the present invention, the blue channel is selected as a reference channel, and the optic values B₁-B_{N} obtained from the blue channel corresponding to the scan lines S₁ to S_{N} are set as reference signals. Take the scan line Sₙ as an example (n is an integer between 1 and N), the third embodiment of the present invention adjusts the optic values Rₙ and Gₙ based on Bₙ. Comparing the actual exposure locations of the optic value Rₙ and Rₙ₊₁ measured by the red channel with the actual exposure location of the reference signal (optic value Bₙ) measured by the reference channel (blue channel), the distance ratio between the optic values Rₙ and Rₙ₊₁ corresponding to the optic value Bₙ is 2:1. Hence, taking adjusting the red channel as an example, in the third embodiment of the present invention, the correction signal of the red channel on the location of the blue reference signal is obtained by linear interpolation, and since the distance ratio of the optic values Rₙ and Rₙ₊₁ corresponding to the optic value Bₙ is 2:1, the weighting values are set as ⅓ and ⅔, and the corresponding correction optic value is adjusted to be (Rₙ+2Rₙ₊₁)/3 when the red channel measures the scan line Sₙ. By the same token, comparing the actual exposure locations of the optic values Gₙ and Gₙ₊₁ measured by the green channel with the actual exposure location of the reference signal (optic value Bₙ) measured by the reference channel (blue channel), the distance ratio between the optic values Gₙ and Gₙ₊₁ corresponding to the optic value Bₙ is 1:2. Hence, taking adjusting the green channel as an example, in the third embodiment of the present invention, the correction signal of the green channel on the location of the blue reference signal is obtained by linear interpolation. Since the distance ratio between the distance of the optic values Gₙ and Gₙ₊₁ corresponding to the optic value Bₙ is 1:2, the weighting value is set as ⅔ and ⅓ respectively, and the correction optic value is adjusted to be (2Gₙ+Gₙ₊₁)/3 when the green channel is measuring scan line Sₙ correspondingly. In the third embodiment of the present invention, the blue channel is the reference channel, so the correction optic value is the same as the original optic value Bₙ when the blue channel is measuring scan line Sₙ correspondingly.

In the embodiments shown in FIG. 7 to FIG. 9, the stepping motor in the scanner is assumed to move in uniform motion. However, the present invention can also apply for motors that do not move in uniform motion. The present invention can be modified as long as an output signal is adjusted based on the difference of actual exposure locations of a reference channel and other channels corresponding to a scan line.

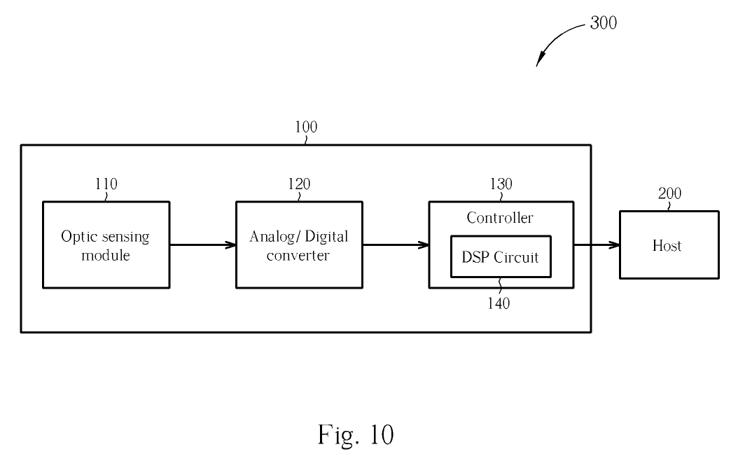

Please refer to FIG. 10, which illustrates a schematic diagram of an image processing system 300 in accordance with the present invention. The image processing system 300 comprises a scanning apparatus 100 and a host 200. The scanning apparatus 100 is an image scanning apparatus such as a scanner, a fax machine, a multi-function printer, etc. The scanning apparatus 100 comprises an optic sensing module 110, an analog-to-digital converter (A/D Converter) 120, and a controller 130. The optic sensing module 110 can include a contact image sensor, which can provide light source for the document to be scanned and detect an optic value based on reflection of the document, and convert an optic signal to an analog optic value. The A/D converter 120 can be an analog front end (AFE) circuit, utilized for converting analog signals from the optic sensing module 110 into digital signals. The controller 130 can process digital signals to generate image signals corresponding to the scanned document, and transfer the image signals to the host 200 to undergo procedures of saving, displaying, printing, transferring, etc.

The image processing system 300 in the present invention can calculate the correction optic values through a main program stored in the controller 130 based on original optic values, or generate the correction optic values through digital signal processing (DSP) circuits in the controller 130. Meanwhile, the image processing system 300 can also calculate the correction optic values through a driving program in the host 200.

In summary, the present invention selects a reference channel from a plurality of channels, and generates corresponding weighting values based on differences of the actual exposure locations of the reference channel and other channels. Then, according to the weighting values, the present invention can correct the original optic values of the channels, so as to generate the correction optic values. Therefore, the present invention can compensate color distortion caused by differences of the actual exposure locations of different channels, and improve the scanning quality.

Those skilled in the art will readily observe that numerous modifications and alterations of the device and method may be made while retaining the teachings of the invention.

What is claimed is:

1. An image scanning compensating method comprising the following steps:
(a) moving an optic sensing module for sequentially scanning a frame and generating a plurality of scan lines;
(b) reading a first original optic value, a second original optic value, and a third original optic value corresponding to an N-th scan line of the plurality of scan lines through a first channel, a second channel, and a third channel of the optic sensing module;
(c) reading a fourth original optic value, a fifth original optic value, and a sixth original optic value corresponding to a (N+1)-th scan line of the plurality of scan lines through the first channel, the second channel, and the third channel of the optic sensing module;
(d) choosing a reference channel from the first channel to the third channel;
(e) adjusting the first original optic value to the third original optic value respectively for generating a first optic compensating signal to a third optic compensating signal according to differences of actual exposure location of the reference channel and actual exposure locations of the first channel to the third channel other than the reference channel when reading the N-th scan line;
(f) adjusting the fourth original optic value to the sixth original optic value respectively for generating a fourth optic compensating signal to a sixth optic compensating signal according to differences of actual exposure locations of the first channel to the third channel other than the reference channel when reading the (N+1)-th scan line and the actual exposure location of the reference channel when reading the N-th scan line;
(g) generating a first correction optic value corresponding to the first channel and the N-th scan line according to the first optic compensating signal and the fourth optic compensating signal;
(h) generating a second correction optic value corresponding to the second channel and the N-th scan line according to the second optic compensating signal and the fifth optic compensating signal;
(i) generating a third correction optic value corresponding to the third channel and the N-th scan line according to the third optic compensating signal and the sixth optic compensating signal; and
(j) outputting image signals corresponding to the N-th scan line according to the first correction optic value to the third correction optic value.

2. The scanning method of claim 1, wherein the optic sensing module is a contact image sensor.

3. The scanning method of claim 1, wherein the first channel, the second channel and the third channel are a red channel, a green channel, and a blue channel of the optic sensing module, respectively.

4. The scanning method of claim 3 further comprising:
sending a red light source to the frame through the red channel;
sending a green light source to the frame through the green channel; and
sending a blue light source to the frame through the blue channel.

5. The scanning method of claim 4 further comprising:
measuring reflection of the red light source from the frame for generating the first original optic value and the fourth original optic value;
measuring reflection of the green light source from the frame for generating the second original optic value and the sixth original optic value; and
measuring reflection of the blue light source from the frame for generating the third original optic value and the sixth original optic value.

6. The scanning method of claim 3, wherein step (d) is choosing the red channel as the reference channel, and the first original optic value and the fourth original optic value are equal to the first correction optic value and the fourth correction optic value respectively.

7. The scanning method of claim 6 further comprising:
generating a first weighting value according to a difference between actual exposure locations of the green channel and the red channel when reading the N-th scan line;
generating a second weighting value according to a difference between actual exposure locations of the green channel and the red channel when reading the (N+1)-th scan line;
multiplying the second original optic value by the first weighting value for generating the second optic compensating signal; and
multiplying the fifth original optic value by the second weighting value for generating the fifth optic compensating signal.

8. The scanning method of claim 6 further comprising:
generating a first weighting value according to a difference between actual exposure locations of the blue channel and the red channel when reading the N-th scan line;
generating a second weighting value according to a difference between actual exposure locations of the blue channel and the red channel when reading the (N+1)-th scan line;
multiplying the third original optic value by the first weighting value for generating the third optic compensating signal; and
multiplying the sixth original optic value by the second weighting value for generating the sixth optic compensating signal.

9. The scanning method of claim 3, wherein step (d) is choosing the green channel as the reference channel, and the second original optic value and the fifth original optic value are equal to the second correction optic value and the fifth correction optic value respectively.

10. The scanning method of claim 9 further comprising:
generating a first weighting value according to the difference between actual exposure locations of the red and the green channel when reading the N-th scan line;
generating a second weighting value according to the difference between actual exposure locations of the red and the green channel when reading the (N+1)-th scan line;
multiplying the first original optic value by the first weighting value for generating the first optic compensating signal; and
multiplying the fourth original optic value by the second weighting value for generating the fourth optic compensating signal.

11. The scanning method of claim 9 further comprising:
generating a first weighting value according to the difference between actual exposure locations of the blue and the green channel when reading the N-th scan line;
generating a second weighting value according to the difference between actual exposure locations of the blue and the green channel when reading the (N+1)-th scan line;
multiplying the third original optic value by the first weighting value for generating the third optic compensating signal; and
multiplying the sixth original optic value by the second weighting value for generating the sixth optic compensating signal.

12. The scanning method of claim 3, wherein step (d) is choosing the blue channel as the reference channel, and the third original optic value and the sixth original optic value are equal to the third correction optic value and the sixth correction optic value respectively.

13. The scanning method of claim 12 further comprising:
generating a first weighting value according to the difference between actual exposure locations of the red and the blue channel when reading the N-th scan line;
generating a second weighting value according to the difference between actual exposure locations of the red and the blue channel when reading the (N+1)-th scan line;
multiplying the first original optic value by the first weighting value for generating the first optic compensating signal; and
multiplying the fourth original optic value by the second weighting value for generating the fourth optic compensating signal.

14. The scanning method of claim 12 further comprising:
generating a first weighting value according to the difference between actual exposure locations of the green and the blue channel when reading the N-th scan line;
generating a second weighting value according to the difference between actual exposure locations of the green and the blue channel when reading the (N+1)-th scan line;
multiplying the second original optic value by the first weighting value for generating the second optic compensating signal; and
multiplying the fifth original optic value by the second weighting value for generating the fifth optic compensating signal.

15. An image scanning apparatus capable of compensating images comprising:
an optic sensing module comprising a plurality of channels, for providing light sources for a frame, detecting a plurality of original optic values based on reflection of the frame, and converting the plurality of original optic values to a plurality of analog signals;
an analog-to-digital converter for converting the plurality of analog signals to a plurality of digital signals; and
a controller for adjusting the plurality of digital signals respectively according to differences of actual exposure locations of the plurality of channels on the frame.

16. The image scanning apparatus of claim 15, wherein the optic sensing module is a contact image sensor (CIS).

17. The image scanning apparatus of claim 15, wherein the analog-to-digital converter comprises an analog front end (AFE) circuit.

18. The image scanning apparatus of claim 15 further comprising a host having a driving program for adjusting the plurality of digital signals according to the differences of the actual exposure locations of the plurality of channels on the frame.
